(19) United States
(12) Patent Application Publication
(10) Pub. No.: US 2025/0245675 A1
(43) Pub. Date: Jul. 31, 2025

(54) HYDROCARBON SUPPLY CHAIN BY USING BLOCK CHAIN

(71) Applicant: SAUDI ARABIAN OIL COMPANY, Dhahran (SA)

(72) Inventors: Ali A. Huraifi, Dhahran (SA); Mohammed A. Aboulsamh, Dhahran (SA); Ahmed S. Zahrani, Dhahran (SA)

(73) Assignee: SAUDI ARABIAN OIL COMPANY, Dhahran (SA)

(21) Appl. No.: 18/424,366

(22) Filed: Jan. 26, 2024

(51) Int. Cl. G06Q 30/018; G06Q 20/02; G06Q 20/10; G06Q 20/38

(52) U.S. Cl. CPC G06Q 30/018; G06Q 20/02; G06Q 20/102; G06Q 20/3825; G06Q 20/3829; G06Q 20/389

(57) ABSTRACT

Systems and methods for hydrocarbon supply chain by using block chain are disclosed. The methods may include creating a paper corporate hydrocarbon product sales agreement for a hydrocarbon product, wherein the paper corporate hydrocarbon product sales agreement is drafted by a buyer and a seller; creating, using the paper corporate hydrocarbon product sales agreement and a sales agreement configuration template, a digitized sales agreement; recording the digitized sales agreement in a smart contract on a blockchain; cryptographically linking a public key, a private key, and a digital signature to the buyer, the seller, and the smart contract on the blockchain; measuring, using measurement devices, measurement data; matching the measurement data with the smart contract on the blockchain; reconciling an invoice, using the measurement data, the public key, the private key, the digital signature, and the blockchain; and paying the reconciled invoice.

### BACKGROUND

Petroleum companies operate and maintain complex hydrocarbon supply chain processes that include selling hydrocarbon products to customers. However, it takes time for an invoice issued by a seller to be certified, acknowledged, and processed by a buyer, following internal verification and processing procedures by both companies. As each party has its own system of records that are not in sync, it is common for an invoice to have mismatched information between the buyer's sales order and the reported measurements. A costly and time-consuming process follows for correction and reconciliation, leading to disputes and corrective actions. The lengthy processing time of customer dispute resolution can also lead to cash flow issues that impact both parties' investment capabilities.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to methods for hydrocarbon supply chain by using block chain. The methods may include creating a paper corporate hydrocarbon product sales agreement for a hydrocarbon product, wherein the paper corporate hydrocarbon product sales agreement is drafted by a buyer and a seller; creating, using the paper corporate hydrocarbon product sales agreement and a sales agreement configuration template, a digitized sales agreement; recording the digitized sales agreement in a smart contract on a blockchain; cryptographically linking a public key, a private key, and a digital signature to the buyer, the seller, and the smart contract on the blockchain; measuring, using measurement devices, measurement data; matching the measurement data with the smart contract on the blockchain; reconciling an invoice, using the measurement data, the public key, the private key, the digital signature, and the blockchain; and paying the reconciled invoice.

In general, in one aspect, embodiments disclosed herein relate to a system for hydrocarbon supply chain by using block chain. The system includes: a paper corporate hydrocarbon product sales agreement for a hydrocarbon product, drafted by a buyer and a seller; a sales agreement configuration template, configured to digitize the paper corporate hydrocarbon product sales agreement; a digitized sales agreement; a smart contract, configured to contain the digitized sales agreement; a blockchain, configured to contain the smart contract; a public key, a private key, and a digital signature, configured to cryptographically link the buyer and the seller to the smart contract on the blockchain; measurement devices, configured to measure measurement data; and an invoice, configured to reconcile the measurement data with the smart contract by using the public key, the private key, and the digital signature.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a blockchain being accessed by a buyer and seller organization in accordance with one or more embodiments.

FIG. 2 shows a supply chain framework in accordance with one or more embodiments.

FIG. 3 shows product loading in a supply chain framework in accordance with one or more embodiments.

FIG. 4A shows a supply chain framework in accordance with one or more embodiments.

FIG. 4B shows a meter reading in accordance with one or more embodiments.

FIG. 5 shows the steps of a new supply chain framework in accordance with one or more embodiments.

FIG. 6 shows the digitization of sales agreements in accordance with one or more embodiments.

FIG. 7 shows a template in accordance with one or more embodiments.

FIG. 8 shows a workflow of a method in accordance with one or more embodiments.

FIG. 9 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

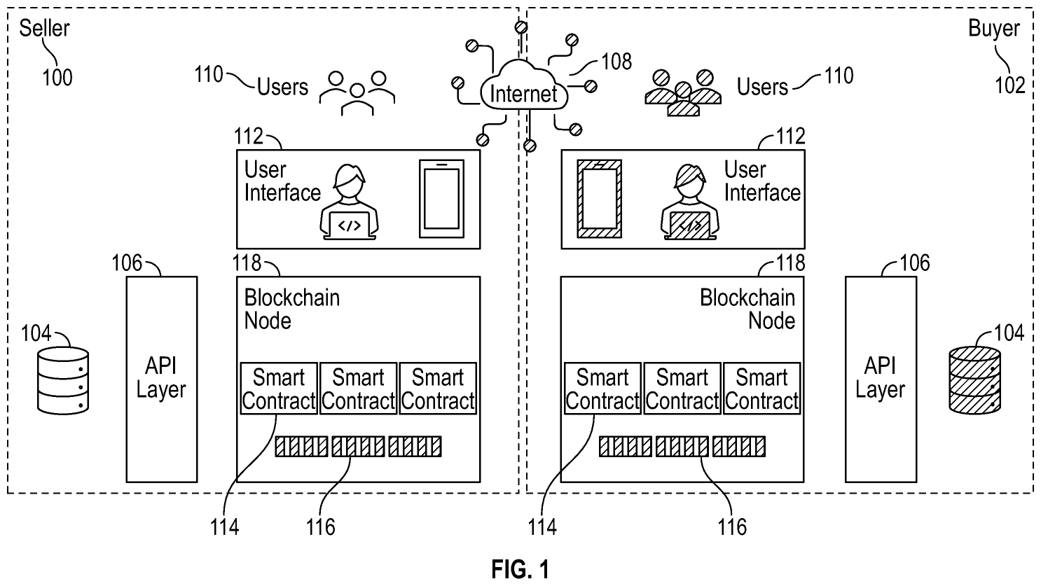

In the following description of FIGS. 1-9, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “blockchain” includes reference to one or more of such blockchains.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Oil companies operate and maintain complex hydrocarbon supply chain processes, covering upstream, mid-stream, and downstream activities. This disclosure describes a method and system for tracking the movement of hydrocarbon products through a supply chain using blockchain technology.

A blockchain is a database/ledger distributed among a network of computers. Blockchains are well known for their role in cryptocurrency systems where they maintain a secure record of transactions in a decentralized fashion across a network. However, blockchains are not limited to cryptocurrency; they may be used in any industry to make data accessible, secure, and inalterable.

The blockchain is used to record the quantity and quality of the hydrocarbon product as the ownership changes from seller to buyer. The method includes a series of steps that enable the creation of key components of blockchain technology, viz., smart contracts and digital signatures. Smart contracts are programs stored on a blockchain that run when predetermined conditions are met. Digital signatures cryptographically link an identity to a message and are difficult, if not impossible, to forge because they are based on cryptographic methods that ensure their security. Public key cryptography permits users of a blockchain to own a public key and a private key, which form a pair. The public key is a proxy for the user's identity, while the private key is a secret known only to the user. The private key allows the user to prove that they own the public key. For digital signatures, a user uses a private key in an algorithm to link a signature to a message and the public key. It is impossible to derive the private key or forge a valid signature using only the signature and the public key. However, if one knows the public key, they can easily verify that the message was signed by someone in possession of the private key.

The blockchain collects transactional data and records it in a block, a form of digital record with a prespecified size. Once the block is full, the information is run through an encryption algorithm that outputs a hexadecimal number called a “hash.” The hash is then entered into the following block's header and is encrypted with the other information in the block. This creates a series of blocks that are chained together and represent the entire history of the blockchain, and that are cryptographically secure from alteration.

Due to the inability to change a block of records on the blockchain, the only trust point is where a user or program enters data into a new block. Trusted third parties are therefore unnecessary to validate a data entry; the absence of third parties removes a potential source of error and fraud.

A blockchain may be spread out among several geographically separated computers on a network, each of which is running the same blockchain software. If an attempt is made to alter a blockchain record on one computer, the other computers on the blockchain network would reject the change, thus preventing modification of the data. This way, no single computer on a blockchain network can, by itself, alter the information held within the blockchain. Due to encryption methods, information and transaction history are unalterable. Records on a blockchain may be any type of information, i.e., legal contracts, top-secret information, an inventory, or, in the case of the embodiments presented in this disclosure, custody transfer transactional information between a hydrocarbon-producing company and a customer.

For a company selling a product (the seller) and another company purchasing the product (the buyer), a custody transfer blockchain solution enables both buyer and seller to have a single channel for reconciling orders and invoices. The blockchain technology allows both parties to have equal access to a shared and distributed system of records, not only for data produced in real time, but also for the entire history of the data along with any modifications.

FIG. 1 presents an example of how a seller and buyer would access transactional information on a blockchain network. Both the seller (100) (comprising all the items contained in the dashed square on the left) and the buyer (102) (comprising all the items contained in the dashed square on the right) have similar internal groups and platforms that interact with a blockchain network. Both have enterprise systems (104), API layers (106) for the enterprise systems (104) to access the blockchain through the internet (108), and enterprise users (110) who interact with the blockchain through some kind of user interface (112). Smart contracts (114) are one data item that is entered on the blocks (116) of the blockchain.

Both the seller (100) and the buyer (102) will have access to at least one computer on the blockchain network, i.e., a blockchain node (118). Since data entered on one blockchain node (118) will eventually spread to be on all the other nodes once confirmed, both seller (100) and buyer (102) each need only access one of the blockchain nodes (118) on the network.

A blockchain's “distributed ledger” of transactions makes transaction clearing and settling nearly instantaneous, and with increased transparency and payment accuracy, thus eliminating reconciliation, disputes, and fraud. Additionally, employing blockchain “smart contract” technology in addition to a distributed ledger may expedite custody transfer transaction processing and thereby reduce transaction resources and time. As blockchain data cannot be altered, the participating parties in a blockchain transaction can have an increased confidence in the data without the requirement for manual checks to ensure compliance. By comparison, without blockchain technology, transactions are not transparent, and reconciling transactions requires orders of magnitude more time. Furthermore, the seller (100) and buyer (102) must trust the validity of data they receive from other partners before finalizing transactions.

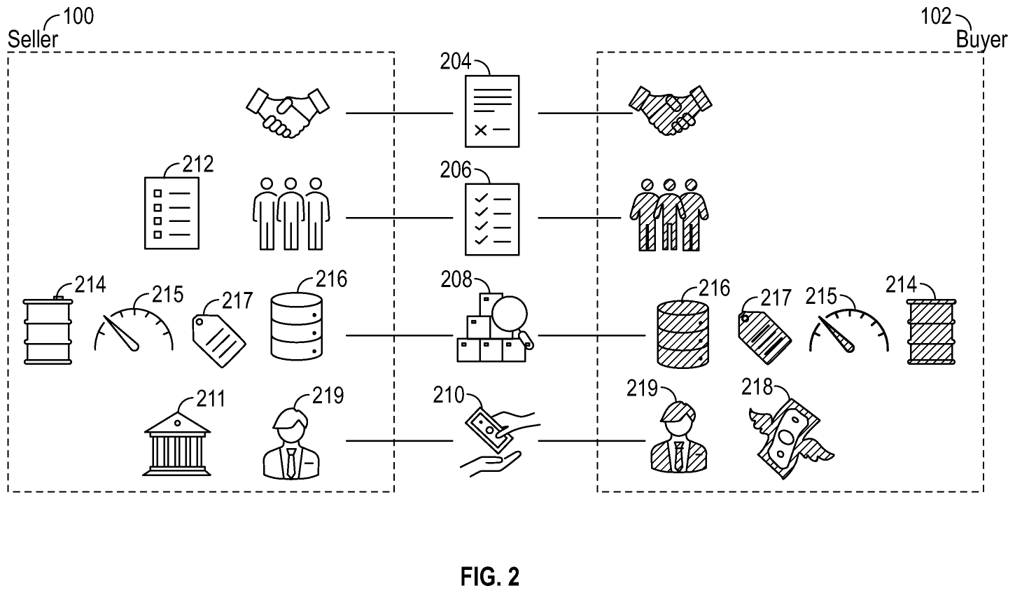

At a high level, as shown in FIG. 2, a hydrocarbon supply chain process may be considered a peer-to-peer energy trading process between the seller (100) (left) and the buyer (102) (right). The process consists of 4 main steps, namely, (Step 1) sales agreement (204) creation, (Step 2) sales order (206) initiation, (Step 3) product loading (208), and (Step 4) trade reconciliation (210). Each of these primary steps is supported by other sub-processes and by systems within each of the trading parties.

More specifically, at the seller side, following the sign-off of the sales agreement (204) (Step 1), a nomination process is performed to define the buyer-contracted product and quantity to be delivered (Step 2). This second step identifies the sales organization, operating facility, and distribution channel. Based on the created nomination (212), the buyer (102) may start initiating sales orders (206) in line with the signed sales agreement (204). The nomination (212) is the scheduling document used to communicate between various scheduling partners, including a scheduler and the carrier. In a SAP PRO system, nominations (212) are used to schedule bulk material shipments and are the basis for subsequent delivery and shipping notifications.

In Step 3, buyer sales orders (206) are passed to operating facilities (214) to fulfil buyer demands through product loading (208), where control systems (216) are used to measure quantities through metering systems (215), issue tickets (217), and assure the quality of produced products. Each product delivered is ticketed with respect to quantity delivered and product quality attributes. A ticket (217) is an object that contains information about the movement of the hydrocarbon product. These delivery tickets (217) may be created and generated in SAP PRO or a similar computer system and are used as a basis for invoicing purposes. In Step 4, an invoice is created, where each invoice contains a description of product sold, quantity, and price as well as total amount due to the seller (100). Payments (218) must be received within the period agreed upon based on the terms stated in the signed sales agreement (204). Payments (218) are handled by accounting staff (219) and are sent directly to the seller's accounts (221) as stipulated by the invoice.

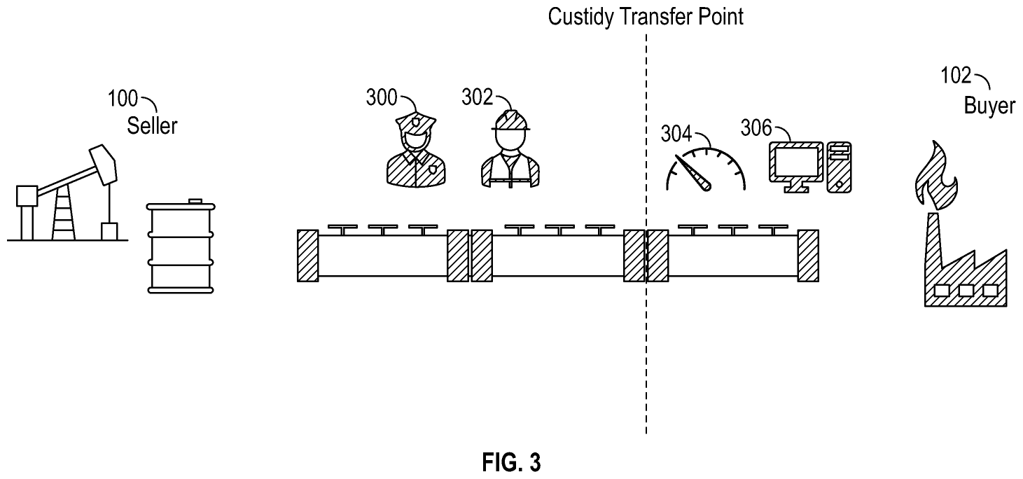

FIG. 3 analyzes in more detail Step 3 of FIG. 2, i.e., product loading (208) in the peer-to-peer hydrocarbon supply chain process. Hydrocarbon product measurement is an essential part of product loading (208) and provides quantity and quality information as the hydrocarbon product changes ownership from seller (100) to buyer (102). The measurement and transfer process of hydrocarbon products may need to be witnessed by a government regulator (300), as stipulated in relevant government regulations to calculate royalties. A 3rd party inspector (302) may also be involved to confirm product quality and quantities delivered, particularly in case of disputes.

The measurement and transfer process is typically carried out using specialized metering devices installed at a buyer site but operated and maintained by the seller (100). Such devices include flow meters (304) and flow computers (306). The flow computers (306) may be installed at buyer facilities to capture flow meter (304) readings every day at a prespecified time. Other data elements captured include opening and closing times and heating value average flow rate, as well as the temperature, pressure, and density of the hydrocarbon product. Pipeline staff maintain, monitor, and review computer-generated tickets (217) related to flow. These delivery tickets (217) are aggregated at the end of each invoicing period (e.g., monthly) and are used as a basis for generating sales invoices.

Other devices used to inspect hydrocarbon product may include provers, sampling devices, and hydrocarbon product gas chromatographs. To meet international custody standards, such as those specified by the American Petroleum Institute, these devices need to be frequently calibrated, tested, and inspected. The seller (100) typically maintains records of the flow meters (304) and devices as well as their calibration and inspection records.

After measurement, a buyer (102) may raise a measurement claim against the loaded product quality or quantity. A claim is recognized when a buyer (102) files an objection in compliance with the signed sales agreement (204) against the billing figures. Claims received are investigated and, based on the outcome of the investigation, booked in specific accounts using debit or credit notes.

To avoid seller-buyer friction points caused when the conventional framework is performed in isolation (FIG. 2), the proposed blockchain method and system are introduced. The proposed invention incorporates an end-to-end approach starting with a seller-buyer sales agreement (204), and ending when sales transactions are paid and reconciled. The proposed method places both seller (100) and buyer (102) into a single, shared, and trusted process. All parties in the process may track product movement, and validate product quantity and quality against sales agreement terms and conditions. The parties may then proactively address any measurement claims as the product moves through the various phases of the supply chain. The disclosed method and system are generic as they may be applied within the context of peer-to-peer hydrocarbon trading irrespective of hydrocarbon product or sales channel.

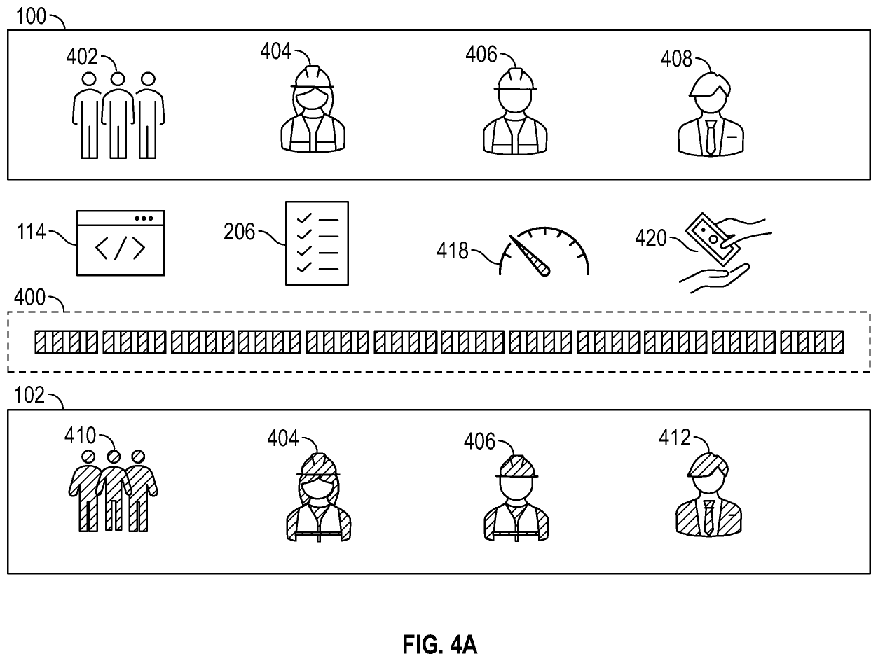

FIG. 4A presents this new method that uses a blockchain (400) to address the limitations of conventional buyer-seller framework. The blockchain (400) records smart contracts (114) (digitally drafted by both seller and buyer administrative staff) that contain all relevant data for a transaction and may be monitored by either the buyer (102) or the seller (100) from the start until the sales transaction is paid and reconciled. The information on the blockchain (400) is also accessible by operations staff (404) and pipeline staff (406), thus keeping all contract data in one place. Seller invoice payment systems (408) and buyer invoice payment systems (412) may also access the data kept on the blockchain (400) when completing a transaction.

As shown in FIG. 4A, various groups within both the seller organization and the buyer organization have simultaneous access to the blockchain (400). For instance, sales staff (402), administrative staff (410), operation staff (404), pipeline staff (406), seller invoice payment systems (408), and buyer invoice payment systems (412) may all view and enter information on the same blockchain (400) whenever desired. The information may include smart contracts (114), sales orders (206), measurement data (418), and invoice payments (420). A sales order (206) is a document generated by the seller (100) specifying the details about the product or services ordered by the buyer (102). Along with the product and service details, a sales order (206) consists of price, quantity, terms and conditions, etc. In comparison, a smart contract (114) is simply a programs stored on a blockchain (400) that run when predetermined conditions are met. A smart contract (114) is used to automate the execution of an agreement so that all participants can be immediately certain of the outcome. Smart contracts (114) are used as self-executing programs that perform the auto-matching of sales orders to avoid buyer-seller sales disputes and claims. In other words, smart contracts (114) are programs stored on a blockchain that run when predetermined conditions are met.

FIG. 4A shows that the blockchain (400) is accessed by all stakeholder from the beginning to the end of a transaction. The blockchain (400) enables both buyers (102) and sellers (100) to have a single mode of operation on a distributed system of records for keeping track of information relevant to a transaction. Without blockchain technology, a buyer organization must determine the validity of each piece of data it receives from the seller (100) before being able to use it. With blockchain technology, however, the buyer (102) and seller (100) may share real-time data, but also may share historical data and any modifications that have been made to the data. Additionally, the distributed ledger of transactions contained on the blockchain (400) makes settling transactions nearly instantaneous, thus increasing transparency, payment accuracy, and eliminating dispute and fraud. Employing smart contracts (114) may expedite transaction processing while reducing computer processing requirements and processing time. Furthermore, the use of smart contracts (114) on a blockchain (400) may improve compliance processes. Since blockchain data cannot be altered, the participating parties in a blockchain transaction may have increased confidence in the data and invoicing.

FIG. 4B shows an example of measurement data (418) that may measured by operations staff (404), pipeline staff (406), a government regulator (300), and 3rd party inspector (302), and that is available on the blockchain (400). Measurement data (418) may be measured by a flow computer (306) or a flow meter (304). As shown in FIG. 4B, measurement data (418) may include a meter closing time (450), a meter opening time (452), an idle time (454), a net delivery time (456), a meter closing reading (458), a meter opening reading (460), a total volume (462), a heating value closing reading (464), a heating value opening reading (466), a total heating value (468), an average flow rate (470), an average temperature (472), an average pressure (474), an average density (476), and an average meter factor (478).

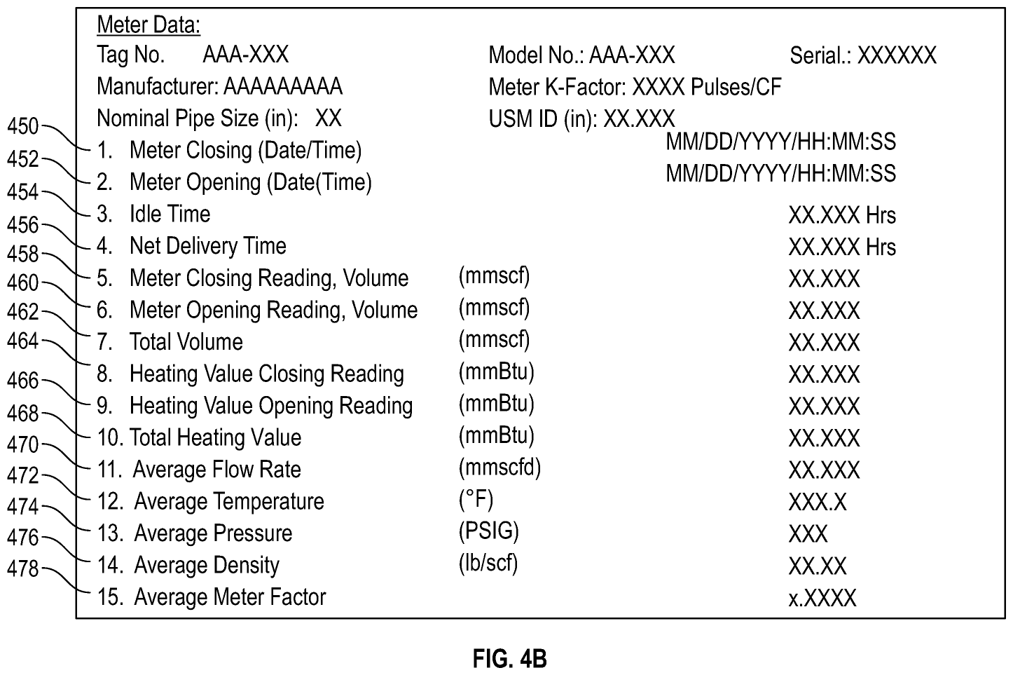

As shown in FIG. 5, there are four steps used by a new method in the new framework (FIG. 4A) to track the movement of hydrocarbon products through a supply chain utilizing blockchain technology. Step 1 (500), involves the custody measurement and transfer process, and is governed by a corporate hydrocarbon product sales agreement (204) with a buyer (102). The sales agreement (204) is digitized in the form of the smart contract (114). The smart contract (114) contains all information related to the hydrocarbon product being sold/bought (quantity, price, etc.), buyer information (registration number, etc.), as well as the terms and conditions of the transaction (the rules related for paying 3rd parties, the payment method, dispute resolution, penalties, etc.). The main benefits of digitizing a sales agreement (204) into a smart contract (114) is to translate the sales agreement terms into parameters that may enable a computer system to add validation checks and verification of the product transfer. This computerized verification process potentially reduces the labor efforts and disputes between both parties. The smart contract (114) is subsequently uploaded onto the blockchain (400).

Step 2 (502) of FIG. 5, uploads information from the seller (100) related to hydrocarbon transportation measurements onto the blockchain (400). The availability of the measurements and the sales data on the blockchain (400) allows the seller and buyer organizations to perform the necessary validation to detect any mismeasurement. This reduces delays caused by disputes and allow automated demonstration of compliance with applicable standards, thus significantly reducing transaction time and costs.

In Step 3 (504) of FIG. 5, buyer data is entered into the blockchain (400) just as it was done for the seller (100). This data includes information related to the quantity and quality of hydrocarbon product to be received. A custody transfer certification algorithm (tied to a smart contract (114)) may be used to match the buyer sales orders with the measurements of transported hydrocarbon product. The custody transfer certification algorithm is triggered each time a buyer (102) receives a new measurement of transported hydrocarbon product.

Finally, in Step 4 (506) of FIG. 5, the seller (100) may use the information on the blockchain (400) to generate an invoice that includes sales order items. The generated invoice may include all information related to sales orders (206) and may be electronically billed to the buyer (102).

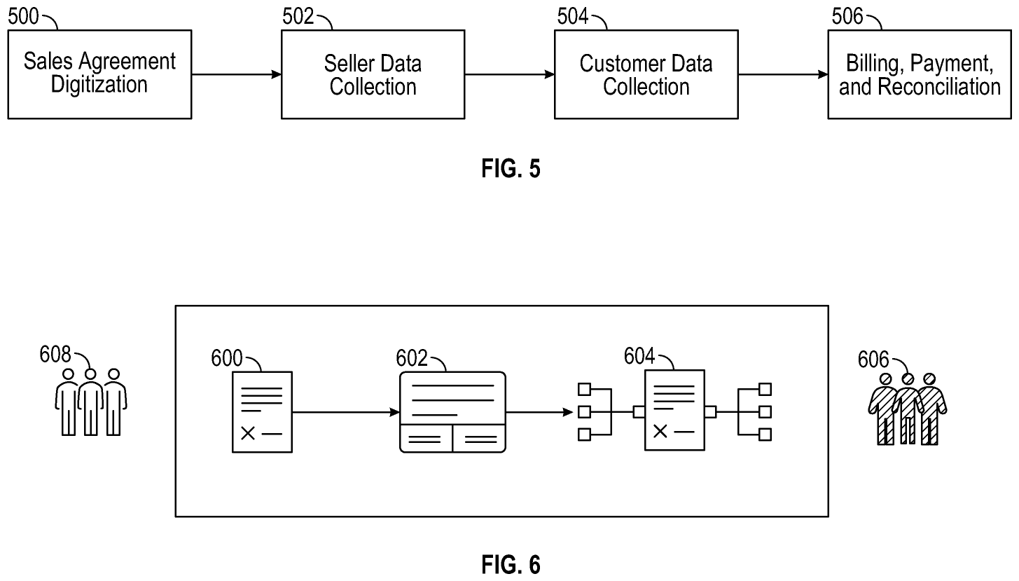

FIG. 6 shows part of Step 1 of FIG. 5, i.e., the process of digitizing a computerized hydrocarbon product sales agreement (604) based on an existing signed paper corporate hydrocarbon product sales agreement (600) drafted jointly by the seller (100) and the buyer (102). Each hydrocarbon product sales agreement (600) presents, in textual format, a number of terms and conditions related to the custody transfer process. The first step of the new method requires this process to be performed by the corporate hydrocarbon product sales organization (608) on the seller side and, on the buyer side, by the hydrocarbon product buyer sales agreement administrator (606). More specifically, this process involves analyzing an existing signed paper hydrocarbon product sales agreement (600) to identify sales line items and sales agreement terms and conditions. To identify sales line items, a standardized computerized sales agreement analysis template (602) is used to produce a computerized hydrocarbon product sales agreement (604).

The paper hydrocarbon product sales agreement (600) is used to capture buyer details, sales agreement details, and sales order line item details. The buyer details may include a buyer registration number, a buyer category, and a buyer location. The sales agreement details may include validity dates, a proponent organization, and an associated sales order. The sales order line items details may include the quantity and unit of measurement of the hydrocarbon product.

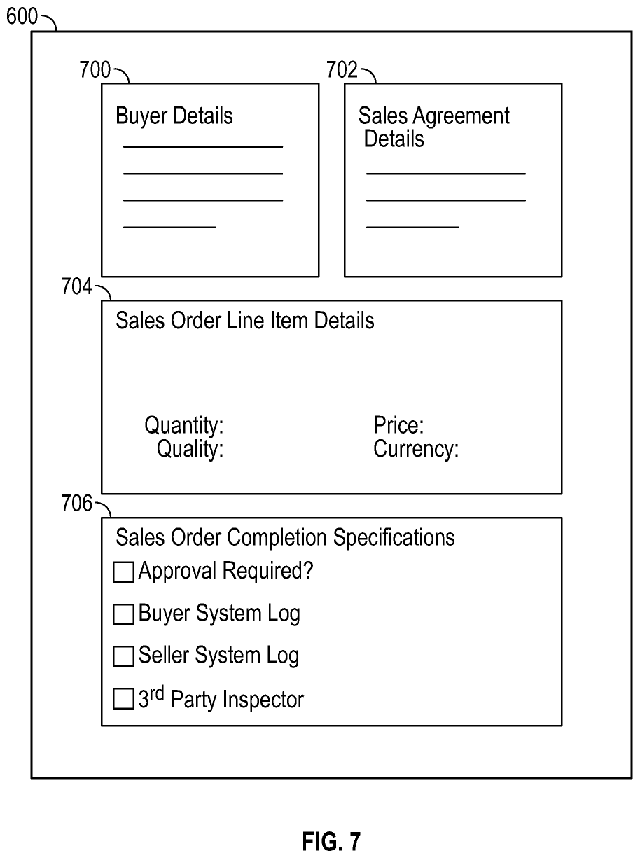

To identify terms and conditions of the sales agreement details, a computerized sales agreement analysis template (602) in the form of a computerized user interface, as shown in FIG. 7, may be used. Fields exist in the computerized sales agreement analysis template (602) for recording buyer details (700), sales agreement details (702), sales order line item details (704), and sales order completion specifications (706). Information in the computerized sales agreement analysis template (602) may be categorized into two categories. The first category includes general clauses relevant to sales agreement payments, sales rates, volume discounts, penalties, dispute resolution and relevant government regulations. The second category includes technical specifications related to sales order completion.

The terms in the sales order line item details (704) may include buyer reports, written documents, system printouts logs, 3^{rd} party inspector evidence, and supporting documents. The completion specifications (706) may also include other parameters such as the meter data (e.g, meter closing, meter opening, idle time (454), net delivery time (456), or volume). Furthermore, a flexible functional check may also be embedded as code in the sales agreement configuration template (602) to enable a hydrocarbon product sales agreement administrator (606) (perhaps with the help of a computer programmer) to add other validation rules related to the sales order line item details (704) being configured.

Key elements of the sales order line item details (704) may include the buyer number, buyer name, sales agreement number, sales agreement title, order quantity, order quality, meter opening time, meter closing time (450), idle time (454), order volume, heating value, flow rate, order temperature, order pressure and order density. This data may be obtained from an enterprise resource planning [ERP] hydrocarbon application and/or a flow computer (306). Other elements, such as sales order line item number, sales order line item description, quantity, unit of measurement, price, and currency may be consolidated from the sales order line item details (704). Such other elements may be collected from different sources/systems.

The above set-up of the computerized sales agreement contract is done upon agreement/sign-off, and is updated before custody transfer throughout the agreement duration. Since the setup of the computerized sales agreement is performed by sales agreement administrators from both the seller (100) and the buyer (102), it constitutes a translation (or a digitalization) of existing paper contracts into a system element, agreed to by both contract parties. Here, the “system element” is a smart contract that is used to digitize the paper contracts/sales agreement.

The main benefits of the digitization of the sales agreement (204) are to translate the sales agreement terms and conditions contained in existing corporate paper agreements into a format that may be configured and used to enable validation checks and verification of a custody transfer in a blockchain (400). This verification method significantly reduces the labor efforts and time spent on dispute resolution incurred by both parties in every custody transfer cycle.

The availability of the real-time measurements and the sales data in the blockchain (400) allows the seller (100) to validate transactions and capture any mismeasurement, thus eliminating costly delays caused by disputes related to data. The presence of the data in the blockchain (400) also allows for automated demonstration of compliance with applicable standards and significantly reduces transaction time and costs. The availability of the buyer-related data including the buyer's sales orders and the measurement data (418) in the blockchain (400) may allow a concerned buyer (102) to match the measurement data (418) against the sales requests.

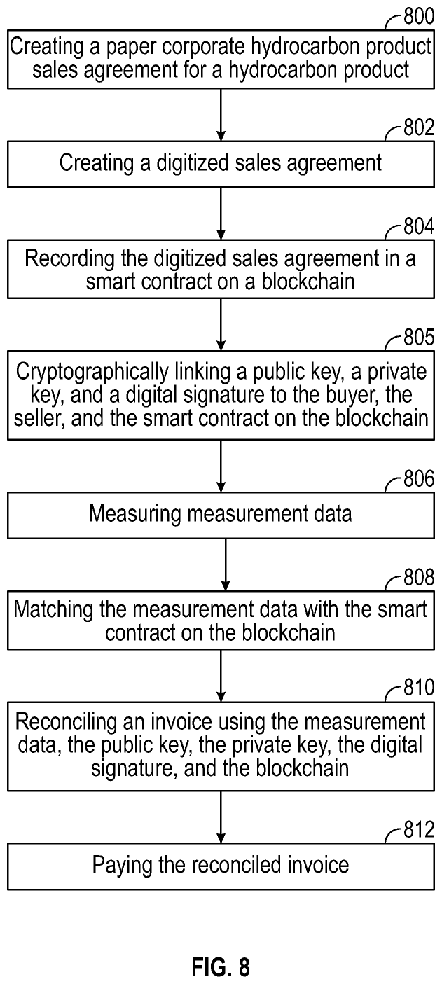

FIG. 8 presents a workflow of the methods presented above. In Step (800), a paper hydrocarbon product sales agreement (600) is created for a hydrocarbon product. The paper hydrocarbon product sales agreement (600) is drafted by both a buyer (102) and a seller (100). The paper hydrocarbon product sales agreement (600) may include details related to the buyer, the sales agreement details (702), as well as line items of the sales order. Buyer details may include a buyer registration number, a buyer category, and a buyer geographic location. The sales agreement details (702) may include dates during which the contract is valid, the seller organization, and the sales order. The sales order line item details (704) may include the quantity and unit of measurement of the hydrocarbon product being sold to the seller (100) from the buyer (102).

In Step (802), a digitized sales agreement is created using the paper corporate hydrocarbon sales agreement along with a sales agreement configuration template. The process of digitizing a sales agreement involves analyzing an existing signed paper hydrocarbon product sales agreement (600) to identify sales line items and sales agreement terms and conditions. To identify sales line items, a standardized computerized sales agreement analysis template (602) is used to produce a computerized hydrocarbon product sales agreement (604).

The paper corporate hydrocarbon product sales agreement (600) may include one or more of the following items: buyer details, sales agreement details (702), and sales order line item details (704). The sales order line item details (704), in turn, may include one or more of the following: buyer reports, written documents, system printout logs, 3^{rd} party inspector evidence, supporting documents, buyer number, buyer name, sales agreement number, sales agreement title, order quantity, order quality, meter opening time, meter closing time, idle time, order volume, heating value, flow rate, order temperature, order pressure, and order density. The sales agreement configuration template may include a flexible functional check such that validation rules may be added to sales order line item details (704).

In Step (804), the digitized sales agreement is recorded in a smart contract on a blockchain (400). Smart contracts (114) may be viewed as programs on the blockchain (400) that run when predetermined conditions are met.

In Step (805), a public key, a private key, and a digital signature are cryptographically linked to the buyer (102), the seller (100), and the smart contract on the blockchain (400). Digital signatures cryptographically link an identity to a message. A public key is a proxy for the user's identity, while the private key is a secret known only to the user. The private key allows the user to prove that they own the public key. For digital signatures, a user uses a private key in an algorithm to link a signature to a message and the public key.

In Step (806), measurement data (418) is measured using measurement devices. The measurement devices may include a flow meter or a flow computer. The measurement data (418) may be available on the blockchain (400) in real time, and may be measured by a 3^{rd} party. When the buyer (102) receives a measurement, a custody transfer certification algorithm is triggered.

In Step (808), the measurement data (418) is matched to the smart contract on the blockchain (400). The matching is performed by both the buyer (102) and the seller (100). The measurement data (418) may measured by operations staff (404), pipeline staff (406), a government regulator (300), and 3^{rd} party inspector (302).

In Step (810), an invoice is reconciled using the measurement data (418), the public key, the private key, the digital signature, and the blockchain (400). In Step (812), the buyer (102) pays the seller (100) according to the reconciled invoice. The generated invoice may include information related to sales orders (206) and may be electronically billed to the buyer (102).

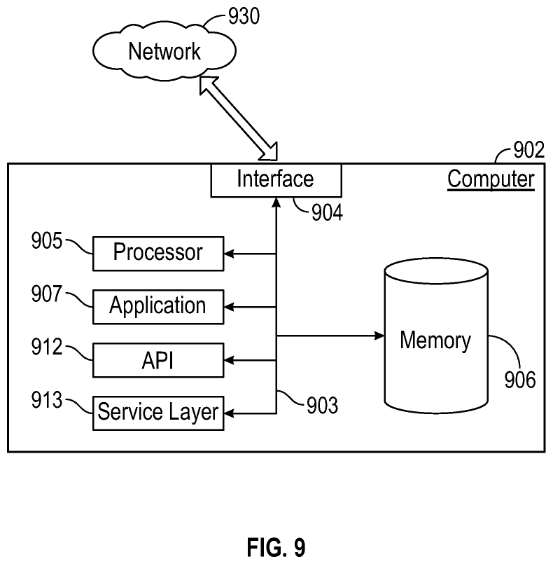

FIG. 9 further depicts a block diagram of a computer system (902) used to provide computational functionalities associated with described algorithms, methods, functions, processes, flows, and procedures as described in this disclosure, according to one or more embodiments. The illustrated computer (902) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (902) may include an input device, such as a keypad, keyboard, touch screen, or other device that can accept user information, and an output device that conveys information associated with the operation of the computer (902), including digital data, visual, or audio information (or a combination of information), or a GUI.

The computer (902) can serve in a role as a client, network component, a server, a database or other persistency, or any other component (or a combination of roles) of a computer system for performing the subject matter described in the instant disclosure. The illustrated computer (902) is communicably coupled with a network (930). In some implementations, one or more components of the computer (902) may be configured to operate within environments, including cloud-computing-based, local, global, or other environment (or a combination of environments).

At a high level, the computer (902) is an electronic computing device operable to receive, transmit, process, store, or manage data and information associated with the described subject matter. According to some implementations, the computer (902) may also include or be communicably coupled with an application server, e-mail server, web server, caching server, streaming data server, business intelligence (BI) server, or other server (or a combination of servers).

The computer (902) can receive requests over network (930) from a client application (for example, executing on another computer (902)) and responding to the received requests by processing the said requests in an appropriate software application. In addition, requests may also be sent to the computer (902) from internal users (for example, from a command console or by other appropriate access method), external or third-parties, other automated applications, as well as any other appropriate entities, individuals, systems, or computers.

Each of the components of the computer (902) can communicate using a system bus (903). In some implementations, any or all of the components of the computer (902), both hardware or software (or a combination of hardware and software), may interface with each other or the interface (904) (or a combination of both) over the system bus (903) using an application programming interface (API) (912) or a service layer (913) (or a combination of the API (912) and service layer (913)). The API (912) may include specifications for routines, data structures, and object classes. The API (912) may be either computer-language independent or dependent and refer to a complete interface, a single function, or even a set of APIs. The service layer (913) provides software services to the computer (902) or other components (whether or not illustrated) that are communicably coupled to the computer (902). The functionality of the computer (902) may be accessible for all service consumers using this service layer. Software services, such as those provided by the service layer (913), provide reusable, defined business functionalities through a defined interface. For example, the interface may be software written in JAVA, C++, or other suitable language providing data in extensible markup language (XML) format or another suitable format. While illustrated as an integrated component of the computer (902), alternative implementations may illustrate the API (912) or the service layer (913) as stand-alone components in relation to other components of the computer (902) or other components (whether or not illustrated) that are communicably coupled to the computer (902). Moreover, any or all parts of the API (912) or the service layer (913) may be implemented as child or sub-modules of another software module, enterprise application, or hardware module without departing from the scope of this disclosure.

The computer (902) includes an interface (904). Although illustrated as a single interface (904) in FIG. 9, two or more interfaces (904) may be used according to particular needs, desires, or particular implementations of the computer (902). The interface (904) is used by the computer (902) for communicating with other systems in a distributed environment that are connected to the network (930). Generally, the interface (904) includes logic encoded in software or hardware (or a combination of software and hardware) and operable to communicate with the network (930). More specifically, the interface (904) may include software supporting one or more communication protocols associated with communications such that the network (930) or interface's hardware is operable to communicate physical signals within and outside of the illustrated computer (902).

The computer (902) includes at least one computer processor (905). Although illustrated as a single computer processor (905) in FIG. 9, two or more processors may be used according to particular needs, desires, or particular implementations of the computer (902). Generally, the computer processor (905) executes instructions and manipulates data to perform the operations of the computer (902) and any algorithms, methods, functions, processes, flows, and procedures as described in the instant disclosure.

The computer (902) also includes a memory (906) that holds data for the computer (902) or other components (or a combination of both) that can be connected to the network (930). For example, memory (906) can be a database storing data consistent with this disclosure. Although illustrated as a single memory (906) in FIG. 9, two or more memories may be used according to particular needs, desires, or particular implementations of the computer (902) and the described functionality. While memory (906) is illustrated as an integral component of the computer (902), in alternative implementations, memory (906) can be external to the computer (902).

The application (907) is an algorithmic software engine providing functionality according to particular needs, desires, or particular implementations of the computer (902), particularly with respect to functionality described in this disclosure. For example, application (907) can serve as one or more components, modules, applications, etc. Further, although illustrated as a single application (907), the application (907) may be implemented as multiple applications (907) on the computer (902). In addition, although illustrated as integral to the computer (902), in alternative implementations, the application (907) can be external to the computer (902).

There may be any number of computers (902) associated with, or external to, a computer system containing computer (902), wherein each computer (902) communicates over network (930). Further, the term “client,” “user,” and other appropriate terminology may be used interchangeably as appropriate without departing from the scope of this disclosure. Moreover, this disclosure contemplates that many users may use one computer (902), or that one user may use multiple computers (902).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
creating a paper corporate hydrocarbon product sales agreement for a hydrocarbon product, wherein the paper corporate hydrocarbon product sales agreement is drafted by a buyer and a seller;
creating, using the paper corporate hydrocarbon product sales agreement and a sales agreement configuration template, a digitized sales agreement;
recording the digitized sales agreement in a smart contract on a blockchain;
cryptographically linking a public key, a private key, and a digital signature to the buyer, the seller, and the smart contract on the blockchain;
measuring, using measurement devices, measurement data;
matching the measurement data with the smart contract on the blockchain, wherein the matching is performed by both the buyer and the seller;
reconciling an invoice, using the measurement data, the public key, the private key, the digital signature, and the blockchain; and
paying the reconciled invoice, wherein the buyer pays the seller.

2. The method of claim 1, wherein the measurement devices are either a flow meter or a flow computer.

3. The method of claim 1, further comprising a custody transfer certification algorithm that is triggered each time the buyer receives a measurement.

4. The method of claim 1, wherein the measurement data is measured by a 3^{rd} party.

5. The method of claim 1, wherein the paper corporate hydrocarbon product sales agreement comprises one or more of the following list: buyer details, sales agreement details, and sales order line item details.

6. The method of claim 5, wherein the sales order line item details comprises one or more of the following list: buyer reports, written documents, system printout logs, 3^{rd} party inspector evidence, supporting documents, buyer number, buyer name, sales agreement number, sales agreement title, order quantity, order quality, meter opening time, meter closing time, idle time, order volume, heating value, flow rate, order temperature, order pressure, and order density.

7. The method of claim 6, wherein a flexible functional check may be embedded in the sales agreement configuration template such that validation rules may be added to the sales order line item details.

8. The method of claim 1, wherein the measurement data are available on the blockchain in real time.

9. A system, comprising:
a paper corporate hydrocarbon product sales agreement for a hydrocarbon product, drafted by a buyer and a seller;
a sales agreement configuration template, configured to digitize the paper corporate hydrocarbon product sales agreement;
a digitized sales agreement;
a smart contract, configured to contain the digitized sales agreement;
a blockchain, configured to contain the smart contract;
a public key, a private key, and a digital signature, configured to cryptographically link the buyer and the seller to the smart contract on the blockchain;
measurement devices, configured to measure measurement data; and
an invoice, configured to reconcile the measurement data with the smart contract by using the public key, the private key, and the digital signature.

10. The system of claim 9, wherein the measurement devices comprise a flow computer and a flow meter, both configured to measure the measurement data.

11. The system of claim 9, further comprising a custody transfer certification algorithm, configured to be triggered each time a buyer receives a measurement.

12. The system of claim 9, wherein the measurement data is measured by a 3^{rd} party.

13. The system of claim 9, wherein the paper corporate hydrocarbon product sales agreement comprises one or more of the following list: buyer details, sales agreement details, and sales order line item details.

14. The system of claim 13, wherein the sales order line item details comprises one or more of the following list: buyer reports, written documents, system printout logs, 3^{rd} party inspector evidence, supporting documents, buyer number, buyer name, sales agreement number, sales agreement title, order quantity, order quality, meter opening time, meter closing time, idle time, order volume, heating value, flow rate, order temperature, order pressure, and order density.

15. The system of claim 14, further comprising a flexible functional, configured to be embedded in the sales agreement configuration template such that validation rules may be added to the sales order line item details.

16. The system of claim 9, wherein the blockchain is configured to make the measurement data available in real time.
